(19) United States
(12) Patent Application Publication
(10) Pub. No.: US 2009/0153654 A1
(43) Pub. Date: Jun. 18, 2009

(54) VIDEO CUSTOMIZED TO INCLUDE PERSON-OF-INTEREST

(76) Inventors: Amy D. Enge, Spencerport, NY (US); John F. Hamilton, JR., Rochester, NY (US)

Correspondence Address: David A. Novais;Patent Legal Staff, Eastman Kodak Company, 343 State Street, Rochester, NY, 14650-2201, US

(21) Appl. No.: 11/958,637

(22) Filed: Dec. 18, 2007

(51) Int. Cl. H04N 7/18; H04N 5/93

(52) U.S. Cl. 348/61; 386/52; 348/E05.024; 386/E05.003

(57) ABSTRACT

One or more input video sequences and a set of person-of-interest (“POI”) information are received. The set of POI information identifies at least one person-of-interest. A particular video sequence is identified that prominently or relatively prominently displays at least the person-of-interest. The particular video sequence is identified from (a) the input video sequence(s), or (b) a portion of the input video sequence, if only one was received, or a portion of one of the input video sequences, if more than one was received. Then, a customized output video is generated from at least a portion or portions of the input video sequence(s), the customized output video being generated based at least upon the set of POI information to include at least the particular video sequence.

### FIELD OF THE INVENTION

This invention relates to generating an output video customized to include a person-of-interest from single or multiple input video sequences.

### BACKGROUND OF THE INVENTION

Personal video recordings of public events, such as school concerts and school sports, are quite common and easily created with the advent of digital imaging. Since there is little or no consumable cost, most parents and friends are quite willing to make their own memory of a personal event. However, the image quality of these personal videos is usually poor due to low lighting levels at the venue, recording equipment quality being consumer grade or lower, and the relative distance being too far between the recording device and an object of interest.

Some venues offer recorded videos to the participants, audience members, or the public, for a fee. But these videos are generic such that the same video is offered to all customers. These videos also may or may not be of higher image quality than what could be produced by, for example, by an audience member's personal recording device. And, it is quite common, that if the venue does offer a video of the event, that it does not allow personal video recording devices to be used during the event.

Accordingly, a need in the art exists for improved ways to generate desirable videos of an event.

### SUMMARY

The above-described need is addressed and a technical solution is achieved in the art by systems and methods for generating a video according to various embodiments of the present invention. In some embodiments of the present invention one or more input video sequences, and a set of person-of-interest (“POI”) information are received. The set of POI information identifies at least one person-of-interest. A particular video sequence is identified that prominently or relatively prominently displays at least the person-of-interest. The particular video sequence is identified from (a) the input video sequence(s), or (b) a portion of the input video sequence, if only one was received, or a portion of one of the input video sequences, if more than one was received. Then, a customized output video is generated from at least a portion or portions of the input video sequence(s), the customized output video being generated based at least upon the set of POI information to include at least the particular video sequence. The customized output video is stored in a processor-accessible memory system.

Accordingly, an output video customized to include the person-of-interest is generated. It can be seen, then, that embodiments of the present invention allow a plurality of different output videos of the same event to be generated, each output video being customized to include its own set of persons-of-interest. In some embodiments, customers who wish to purchase a customized output video have the ability to specify the person or persons-of-interest they want in their customized output video.

In some embodiments, the input video sequence(s) include(s) images of an event spanning a period of time, and a set of times-of-interest (“TOI”) information is received. The TOI information identifies particular times-of-interest within the event's period of time. In these instances, the customized output video is generated to include video from the particular times-of-interest within the event's period of time based at least upon the TOI information. Accordingly, for example, these embodiments allow a customer who wants a customized output video of an event to select particular spans of time of the event that are of interest to the customer, thereby further increasing customization options.

In some embodiments of the present invention, a plurality of input video sequences are received, and the customized output video is generated from at least a portion or portions of at least two of the received plurality of video sequences. Some of these embodiments have the customized output video generated to include two video sequences from the plurality of input video sequences in a picture-in-picture configuration. Also, in some of these embodiments one of the plurality of input video sequences represents a wide-angle view of an event, and another of the plurality of input video sequences represents a zoomed-in view of the event.

In addition to the embodiments described above, further embodiments will become apparent by reference to the drawings and by study of the following detailed description.

### BRIEF DESCRIPTION OF THE DRAWINGS

The present invention will be more readily understood from the detailed description of exemplary embodiments presented below considered in conjunction with the attached drawings, of which:

FIG. 1 illustrates a video production system, according to an embodiment of the present invention;

FIG. 2 illustrates an input/output diagram of a video production system, according to an embodiment of the present invention;

FIG. 3 illustrates a video event input data, according to an embodiment of the present invention;

FIG. 4 illustrates input video information, according to an embodiment of the present invention;

FIG. 5 illustrates input audio information, according to an embodiment of the present invention;

FIG. 6 illustrates sets of interest information, according to an embodiment of the present invention;

FIG. 7 illustrates, among other things, a set of person-of-interest information, according to an embodiment of the present invention;

FIG. 8 illustrates video event output data, according to an embodiment of the present invention;

FIG. 9 illustrates an example of an output customized event video, according to an embodiment of the present invention; and

FIG. 10 illustrates a second example of an output customized event video, according to an embodiment of the present invention.

It is to be understood that the attached drawings are for purposes of illustrating the concepts of the invention and may not be to scale.

### DETAILED DESCRIPTION

Embodiments of the present invention pertain to generating an output video customized to include a person-of-interest from single or multiple input video sequences. In this regard, some embodiments of the present invention relate to generating a plurality of different output videos of a same event, each output video being customized to include its own set of one or more persons-of-interest. Further, in some embodiments, customers who wish to purchase a customized output video have the ability to specify the person or persons-of-interest they want in their customized output video. Accordingly, many different output videos of an event can be generated such that each output video is customized specifically for the person or people who wish to purchase it.

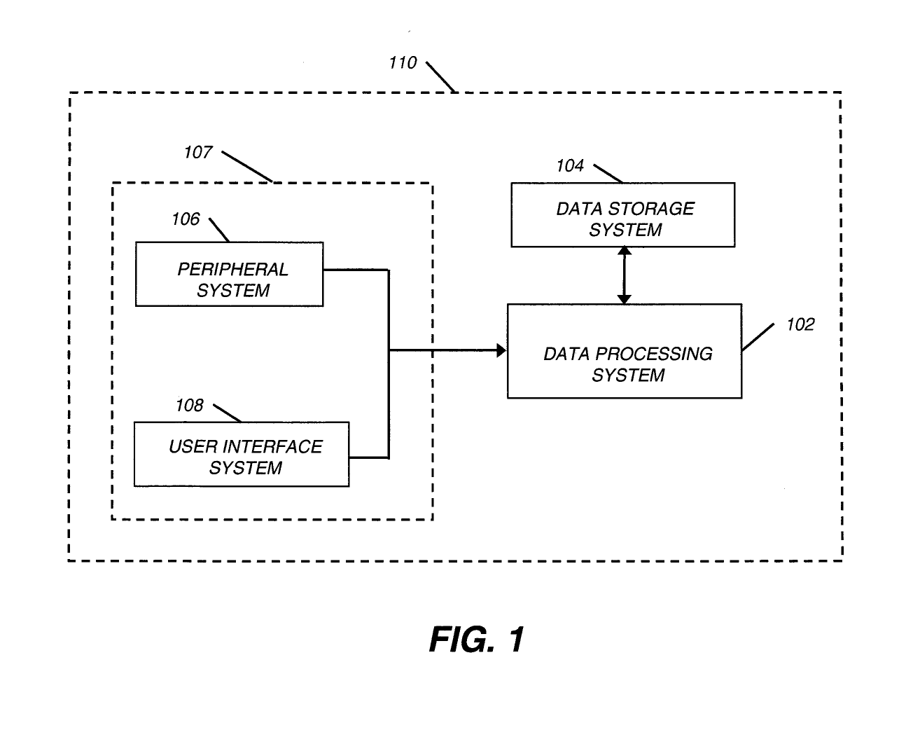

FIG. 1 illustrates a video production system 110, according to an embodiment of the present invention. The video production system 110 includes a data processing system 102, such as a computer system, a peripheral system 106, a user interface system 108, and a data storage system 104 (also referred to as a processor-accessible memory system). An input system 107 includes the peripheral system 106 and the user interface system 108. The data storage system 104 and the input system 107 are communicatively connected to the data processing system 102.

The data processing system 102 includes one or more data processing devices that implement the processes of the various embodiments of the present invention, including the example processes described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

The data storage system 104 includes one or more processor-accessible memories configured to store the information needed to execute the processes of the various embodiments of the present invention. The data-storage system 104 may be a distributed data-storage system including multiple processor-accessible memories communicatively connected to the data processing system 102 via a plurality of computers and/or devices. On the other hand, the data storage system 104 need not be a distributed data-storage system and, consequently, may include one or more processor-accessible memories located within a single computer or device.

The phrase “processor-accessible memory” is intended to include any processor-accessible data storage device, whether volatile or nonvolatile, electronic, magnetic, optical, or otherwise, including but not limited to, floppy disks, hard disks, Compact Discs, DVDs, flash memories, ROMs, and RAMs.

The phrase “communicatively connected” is intended to include any type of connection, whether wired or wireless, between devices, data processors, or programs in which data may be communicated. Further, the phrase “communicatively connected” is intended to include a connection between devices and/or programs within a single computer, a connection between devices and/or programs located in different computers, and a connection between devices not located in computers at all. In this regard, although the data storage system 104 is shown separately from the data processing system 102, one skilled in the art will appreciate that the data storage system 104 may be stored completely or partially within the data processing system 102. Further in this regard, although the peripheral system 106 and the user interface system 108 are shown separately from the data processing system 102, one skilled in the art will appreciate that one or both of such systems may be stored completely or partially within the data processing system 102.

The peripheral system 106 may include one or more devices configured to provide information, including, for example, video sequences to the data processing system 102 used to facilitate generation of output video information as described herein. For example, the peripheral system 106 may include digital video cameras, cellular phones, regular digital cameras, or other computers. The data processing system, upon receipt of information from a device in the peripheral system 106, may store it in the data storage system 104.

The user interface system 108 may include a mouse, a keyboard, a mouse and a keyboard, or any device or combination of devices from which data is input to the data processing system 102. In this regard, although the peripheral system 106 is shown separately from the user interface system 108, the peripheral system 106 may be included as part of the user interface system 108.

The user interface system 108 also may include a display device, a plurality of display devices (i.e. a “display system”), a computer accessible memory, one or more display devices and a computer accessible memory, or any device or combination of devices to which data is output by the data processing system 102.

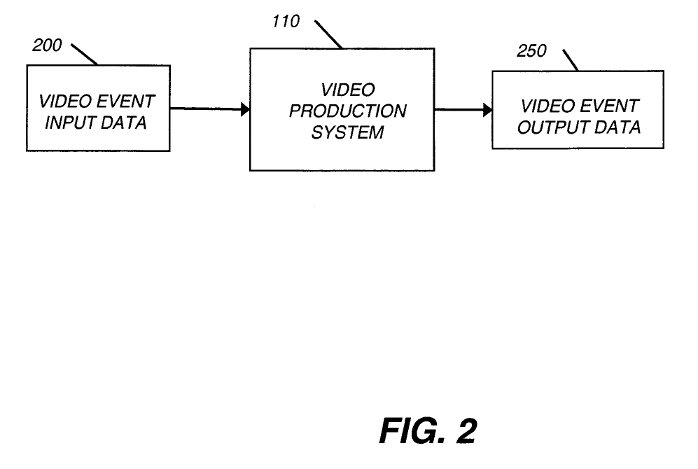

FIG. 2 illustrates an input/output diagram of the video production system 110, according to an embodiment of the present invention. In this regard, video event input data 200 represents information input to the video production system 110 for the generation of video event output data 250. The video event input data 200 may be input to and correspondingly received by the data processing system 102 of the video production system 110 via the peripheral system 106, the user interface system 108, or both. Similarly, the video event output data 250 may be output by the data processing system 102 via the data storage system 104, the peripheral system 106, the user interface system 108, or combinations thereof.

As will be detailed below, the video event input data 200 includes one or more input video sequences and, optionally, additional audio or other information. Further, the video event input data 200 includes one or more sets of interest information each indicating at least one or more persons-of-interest. At least the set(s) of interest information are used by the data processing system 102 of the video production system 110 to generate the video event output data 250. The video event output data 250 includes one or more customized output videos generated by the video production system 110.

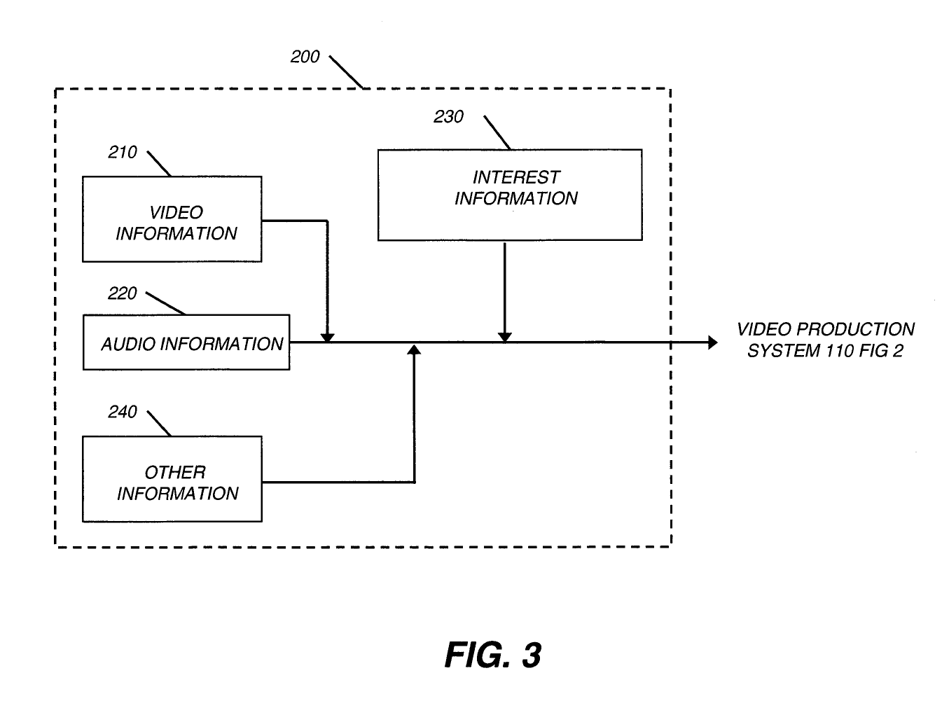

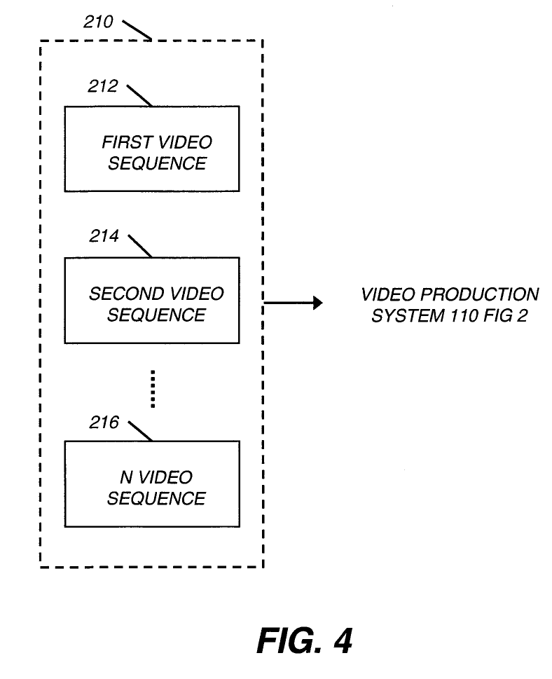

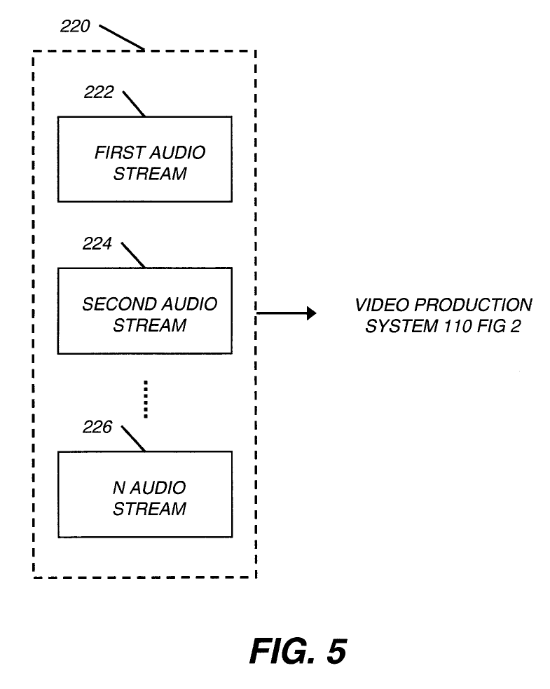

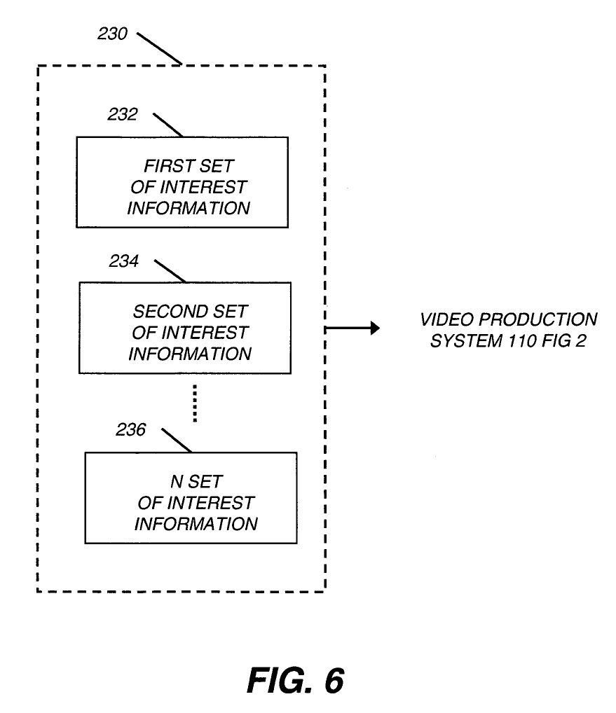

Referring to FIG. 3, video event input data 200 is shown in greater detail, according to an embodiment of the present invention. In the video event input data 200, several bodies of information 210, 220, 230, 240 are shown that may be used by the video production system 110 to generate video event output data 250. Input video information 210 includes one or more input video sequences elaborated upon with respect to FIG. 4, below. Optional audio information 220 includes one or more audio streams elaborated upon with respect to FIG. 5, below. Interest information 230 includes a set of person-of-interest (“POI”) information and, optionally, other sets of interest information, used by the data processing system 102 to generate video event output data 250. The interest information 230 is elaborated upon with respect to FIG. 6, below. Optionally, other information 240 may be provided as input to the video production system 110 to facilitate customization of video. In this regard, such other information 240 includes auxiliary information that may be added to a final video output as part of video event output data 250, such as multimedia content, music, animation, text, etc.

Referring to FIG. 4, input video information 210 is shown as including multiple input video sequences 212, 214, . . . 216, according to an embodiment of the present invention. One skilled in the art will appreciate, however, that input video information 210 may include only a single input video sequence. In the embodiment of FIG. 4, the multiple video sequences include a first video sequence 212, a second video sequence 214, and, ultimately, an n video sequence 216. These sequences may originate from a single video camera or several video cameras recording the same event. At least some of the input video sequences may also be cropped regions-of-interest from a single or multiple video cameras. In one embodiment, a single video camera is used if it has enough resolution to crop regions-of-interest in a final output video. Alternatively, one or more wide-view and narrow view video cameras may be used to capture an event from various views. Further, a number of wide angle cameras located closer to the event may be used to capture smaller groups of persons-of-interest. In this regard, one of the input video sequences 212, 214, . . . 216 may represent a wide-angle view of an event, and another of the input video sequences 212, 214, . . . 216, may represent a zoomed-in view of the event. Accordingly, one skilled in the art will appreciate that the invention is not limited to any particular configuration of cameras used to provide input video sequences 212, 214, . . . 216 or to any particular format of content within the input video sequences 212, 214, . . . 216.

Referring now to FIG. 5, audio information 220 is shown as including multiple audio streams 222, 224, . . . 226, according to an embodiment of the present invention. One skilled in the art will appreciate, however, that audio information 220 may include only a single audio stream. In the embodiment of FIG. 5, the multiple audio streams include a first audio stream 222, a second audio stream 224, and, ultimately, an n audio stream 226. These audio streams may originate from one or more microphones recording audio of a same event. The microphones may be part of a video camera providing input video information 210 or may be separate units. One or more wide-view and narrow view microphones may capture the entire event from various views. A number of wide angle microphones located closer may be used to target audio input for a smaller groups of persons-of-interest. In one embodiment, at least one of the customized output videos in the video event output data 250 includes audio content from one of the audio streams 222, 224, 226. In this regard, such a customized output video may include audio content from one or more of the audio streams 222, 224, 226 in place of any audio content associated with any of the video sequences in input video information 210.

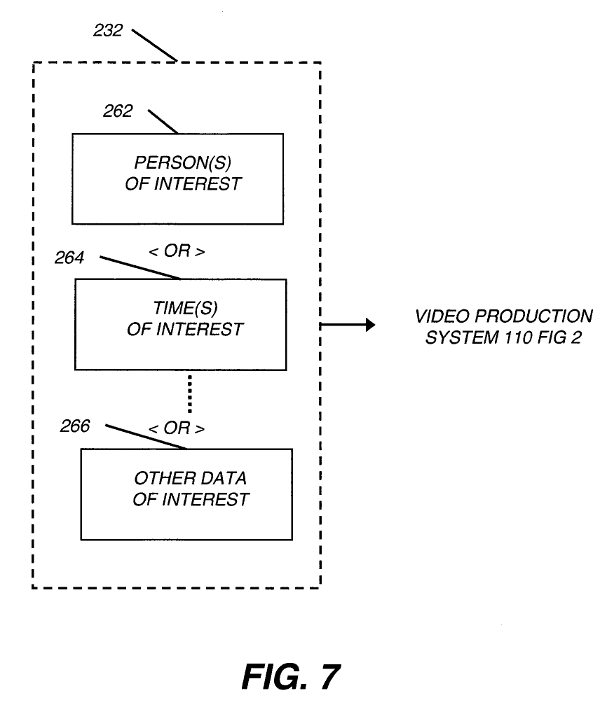

Referring to FIG. 6, the interest information 230 is shown to include a plurality of sets of interest information 232, 234, . . . 236, according to an embodiment of the present invention. One skilled in the art will appreciate, however, that the interest information may include only a single set of person-of-interest information, as will become more clear below, with respect to the discussions of FIG. 7. In the embodiment of FIG. 6, the interest information 230 includes a first set of interest information 232, a second set of interest information 234, and, ultimately, an n set of interest information 236. The sets of interest information 232, 234, . . . 236 are used by the data processing system 102 of the video production system 110 to customize output videos in video event output data 250.

To elaborate, for example, each set of interest information 232, 234, . . . 236 identifies a person-of-interest 262; a time-of-interest 264; or other data of interest 266 information, as shown by FIG. 7. However, at least one of the sets of interest information 232, 234, . . . 236 identifies a person-of-interest, so that an output video in video event output data 250 can be customized to include at least the person-of-interest. In this regard, a set of interest information that identifies a person-of-interest is referred to herein as a set of person-of-interest (“POI”) information. In some embodiments, at least one person-of-interest is a participant in the relevant event. However, the person-of-interest need only be someone identifiable in one of the input video sequences 212, 214, . . . 216.

A set of interest information that identifies a time-of-interest is referred to herein as a set of time-of-interest (“TOI”) information. Times-of-interest identify any time information that is useful for producing the final video output. For example, a set of TOI information may identify particular times-of-interest within the event's period of time that have a preference of being included in a corresponding customized output video. Further, such times-of-interest may be associated with a particular set of POI information, to facilitate designation of starting and ending times for highlighting the persons-of-interest, in the corresponding customized video output.

Other data of interest 266 may include other identifiers of interest to create a corresponding customized output video, such as audio markers or lighting markers that signify the start or termination of a particular event, or additional media content (such as music, voice-over, animation) that is incorporated in the final output video. One skilled in the art will appreciate that additional content may include content for smell, touch and taste as the video display technology becomes more capable of incorporating these other stimuli.

In another embodiment, data of interest are identified during a review of the entire video. The person can identify persons-of-interest and times-of-interest by some input method such as a touch screen or mouse click.

Various methods are available to identify or mark the different inputs of interest. In order to identify the person-of-interest, in the example of events with fixed performer locations, such as a school band concert, a seat identification method may be used. Each input video sequence may then be predefined to capture a particular set of performer locations. For example, an input video sequence that captures a wide-angle view of all event performers will be predefined to have captured all performer locations. However, an input video sequence that captures a small group of performers may be predefined to have captured only those performer locations associated with the small group. Further, for sporting activities, a player's number would be used, and corresponding image recognition techniques known in the art may be used by the data processing system 102 to determine which input video sequences capture which players. Additionally, face recognition applications known in the art may be employed to identify a person-of-interest in an input video sequence.

In order to identify times of interest, automatic methods, manual methods, or both, may be used. In the example of a concert event, the data processing system 102 may be configured to automatically identify the start of each song that is being played. This may accomplished by identifying pauses between songs or identifying applause. If a time-of-interest is identified as a third song in a concert event, the data processing system 102 may be configured to highlight the third song in a corresponding customized output video. In the example of a football game, the change in score could be used to identify times-of-interest. This may be accomplished if a time-of-interest is identified as a kickoff or field goal kick. The data processing system 102 may be configured to highlight the time of a touchdown since the next play will be the one of interest.

Another method to mark the times of interest may include a manual method by an attendee at the event. A stopwatch-type device supplied by the venue may allow the attendee control of the times of interest. Such a stopwatch-type device may be synchronized with the video capture devices. As a time of interest occurs, the person clicks the stopwatch-type device to mark the time. The stopwatch-type device is able to handle multiple highlighted times as well as start and stop times.

Accordingly, one skilled in the art will appreciate that the invention is not limited to any particular technique for identifying persons-of-interest, times-of-interest, or other data-of-interest in input video sequences, and that any technique may be used.

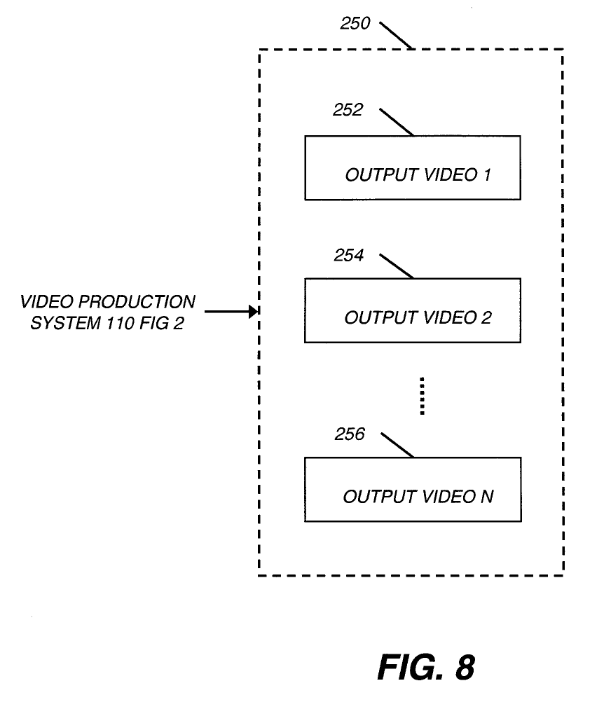

FIG. 8 shows that the video event output data 250 includes a plurality of customized versions of the video. Each of the output videos 252, 254, . . . 256 is customized by the video production system 110 based at least upon a set of person-of-interest (“POI”) information from the sets of interest information 230, an input video sequence from the input video information 210, and, optionally, a set of other interest information from the sets of interest information 230. In this regard, each customized output video is generated based at least upon one corresponding set of POI information within interest information 230. For example, assume that each set of interest information 232, 234, . . . 236 in FIG. 6 is a set of POI information. In this example, output video 252 may be generated based at least upon a set of interest information 232, and output video 254 may be generated based at least upon a set of interest information 234, etc. For another example, assume that the set of interest information 232 in FIG. 6 is a set of POI information, that the set of interest information 234 in FIG. 6 is a set of TOI information, and that the set of interest information 236 in FIG. 6 is a set of other data of interest information. In this example, output video 252 may be generated based at least upon sets of interest information 232, 234, and 236. Accordingly, one skilled in the art will appreciate that any arrangement of correspondence between set of interest information (FIG. 6, for example) and output video (FIG. 8, for example) may be used, so long as a set of POI information is associated with an output video.

Further in this regard, although each set of interest information 232, 234, . . . 236 in FIG. 6 is referred to herein as including only a set of POI information (262 in FIG. 7, for example), a set of TOI information (264 in FIG. 7, for example), or a set of other data of interest information (266 in FIG. 7, for example), one skilled in the art will appreciate that this characterization of FIG. 6 is merely a convention. Accordingly, one skilled in the art will appreciate that FIG. 6 could equally and alternately be described such that each set of interest information 232, 234, . . . 236 is deemed to include multiple subsets of different interest information. For example, set of interest information 232 could be deemed to include a set of POI information and a set of TOI information, set of interest information 234 could be deemed to include a set of POI information a set of TOI information, and a set of other data of interest information, etc. Accordingly, one skilled in the art will appreciate that the invention is not limited to any particular arrangement of interest information within sets of interest information 232, 234, . . . 236.

As stated earlier, each output video 252, 254, . . . 256 is generated from at least a portion or portions of the input video sequences 212, 214, . . . 216 and a set of POI information. To accomplish this, according to an embodiment of the present invention, the data processing system 102 identifies a particular video sequence that prominently or relatively prominently displays at least the person-of-interest identified in the corresponding set of POI information. The particular video sequence is identified from (a) the input video sequence(s), or (b) a portion of the input video sequence, in the case that only one input video sequence was received, or a portion of one of the input video sequences, if more than one input video sequence was received. In this regard, each customized output video 252, 254, . . . 256 is generated based at least upon a corresponding set of POI information to include at least the particular video sequence.

In some embodiments of the present invention, at least one of the output videos 252, 254, . . . 256 have a picture-in-picture format having a smaller video-viewing area superimposed on a larger video-viewing area. In some of these embodiments, a particular video sequence that prominently or relatively prominently displays at least the person-of-interest is displayed in the smaller video-viewing area. Also, in embodiments where one of the input video sequences 212, 214, . . . 216 represents a wide-angle view of an event, and another of the input video sequences 212, 214, . . . 216, represents a zoomed-in view of the event, a customized output video may be generated to include a picture-in-picture format utilizing at least the wide-angle view and the zoomed-in view.

### EXAMPLE

For purposes of clarity, an example of a school band concert event will be provided. At the location of the event, lighting and recording equipment are optimized to obtain good image and sound quality. Several video cameras that supply the input video information 210 record the event from various views. A wide-angle camera at a distance captures the entire concert. A number of wide-angle cameras located closer to the stage capture smaller groups of players. Alternatively, a single video camera is used to capture the event if it has enough resolution to crop regions of interest in the final video. Microphones, to supply the audio information 220, are located with the video equipment as well as targeted locations near the performers.

An individual, who is planning on attending or who is attending the school band concert, prepays or selects a video product, by identifying persons, as well as times or other items of interest. This information may be received by the system 110 through the interface system 108 as shown in FIG. 1. Each video product has one or more associated sets of interest information (232, 234, . . . 236, for example) that is/are used to customize a corresponding output video.

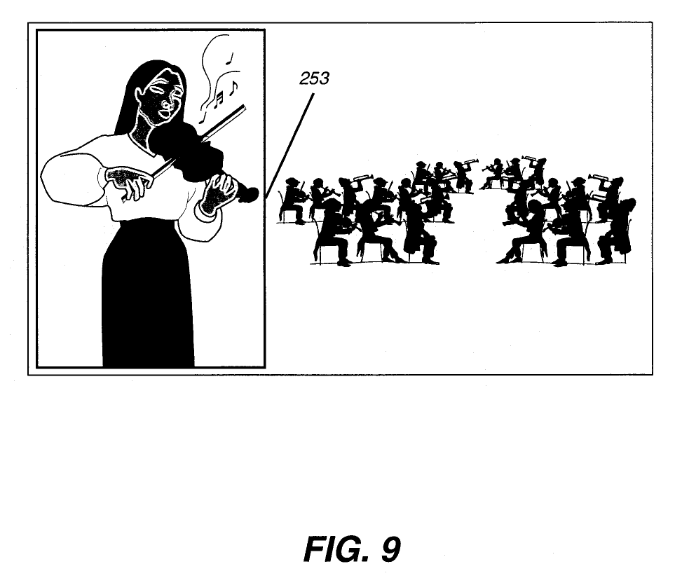

For example, one parent requests to have a close-up portion of his daughter playing the violin during a selected solo on his customized output video. The parent identifies the location of his daughter, the name of the music piece for the solo and other types of customizations desired. With this information, a particular video sequence from the input video sequences 212, 214, . . . 216 is identified by the data processing system 102. In this case, the particular video sequence may be a portion of an input video sequence captured by a camera focused on a small group of performers that has been zoomed-in and cropped to focus on the daughter (i.e., person-of-interest). Referring to FIG. 9, the close-up of the daughter (i.e., the particular video sequence) may be presented in a customized output video in a picture-in-picture format, with the close-up within a smaller viewing area 253 superimposed on a larger viewing area showing video of the entire band.

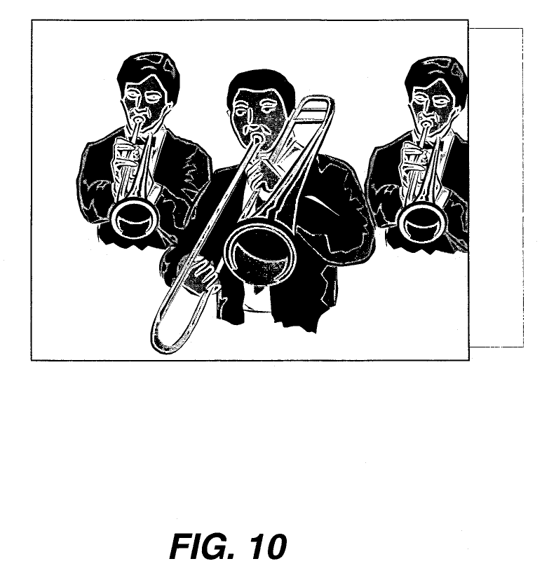

At the same school band concert, another parent requests to have a close-up portion her son playing the trombone on her customized output video, as shown in FIG. 10. The parent identifies the location of her son and selects to have random times for close-ups throughout the band concert.

The system 110 may have varying levels of automation. A fully automated system may have editing software that automatically select portions of the video with prescribed action or content and trims the rest of the video, according to techniques known in the art. It would also merge (e.g., picture-in-picture) close-up segments into the final video. Such editing software may have the capability of identifying the appropriate cropped portion of the close up segments to be inserted into the customized output video. In the above example, one parent requested to have a close-up portion of his daughter playing the violin in his output video, while another parent requested to have a close-up portion of her son playing the trombone on her video. The editing software would automatically identify and crop each portion specifically for each video product, according to techniques known in the art.

### PARTS LIST

102 Data processing system
104 Data storage system
106 Peripheral system
107 Input system
108 User interface system
110 Video production system
200 Video event input
210 Video information
212 First video sequence
214 Second video sequence
216 N video sequence
220 Audio information
222 First audio stream
224 Second audio stream
226 N audio stream
230 Interest information
232 First set of interest information
234 Second set of interest information
236 N set of interest information
240 Other information
250 Video event output
252 Output video 1
253 Picture-in-picture type element
254 Output video 2
256 Output video N
262 Persons-of-interest
264 Times of interest
266 Other data of interest

What is claimed is:

1. A method implemented at least in part by a data processing system, the method for generating a video and comprising the steps of:
receiving one or more input video sequences;
receiving a set of person-of-interest (“POI”) information identifying at least one person-of-interest;
identifying a particular video sequence that prominently or relatively prominently displays at least the person-of-interest, wherein the particular video sequence is identified from (a) the input video sequence(s), or (b) a portion of the input video sequence, if only one was received, or a portion of one of the input video sequences, if more than one was received;
generating a customized output video from at least a portion or portions of the input video sequence(s), the customized output video being generated based at least upon the set of POI information to include at least the particular video sequence; and
storing the customized output video in a processor-accessible memory system.

2. The method of claim 1,
wherein the input video sequence(s) include(s) images of an event spanning a period of time,
wherein the method further comprises the step of receiving a set of times-of-interest (“TOI”) information,
wherein the TOI information identifies particular times-of-interest within the event's period of time, and
wherein the customized output video is generated to include video from the particular times-of-interest within the event's period of time based at least upon the TOI information.

3. The method of claim 1,
wherein the input video sequence(s) include(s) images of an event, and
wherein the person-of-interest is a participant in the event.

4. The method of claim 1,
wherein the person-of-interest is a first person-of-interest,
wherein the POI information identifies at least the first person-of-interest and a second person-of-interest, and
wherein the particular video sequence prominently or relatively prominently displays at least the first person-of-interest and the second person-of-interest.

5. The method of claim 1,
wherein the person-of-interest is a first person-of-interest,
wherein the POI information identifies at least the first person-of-interest and a second person-of-interest,
wherein the particular video sequence is a first particular video sequence,
wherein the method further comprises the step of identifying a second particular video sequence that prominently or relatively prominently displays at least the second person-of-interest, wherein the second particular video sequence is identified from (a) the input video sequence(s), or (b) a portion of the input video sequence, if only one was received, or a portion of one of the input video sequences, if more than one was received, and
wherein the customized output video is generated based at least upon the set of POI information to include at least the first particular video sequence and the second particular video sequence.

6. The method of claim 1, further comprising the step of receiving audio content, wherein the customized output video includes the received audio content.

7. The method of claim 1,
wherein the step of receiving one or more input video sequences receives a plurality of input video sequences, and
wherein the customized output video is generated from at least a portion or portions of at least two of the plurality of input video sequences.

8. The method of claim 7, wherein one of the plurality of input video sequences represents a wide-angle view of an event, and another of the plurality of input video sequences represents a zoomed-in view of the event.

9. The method of claim 7, wherein the customized output video is generated to include two video sequences from the plurality of input video sequences in a picture-in-picture configuration.

10. The method of claim 8, wherein the customized output video is generated to include a picture-in-picture format utilizing at least the wide-angle view and the zoomed-in view.

11. The method of claim 1, wherein the customized output video is generated to include a picture-in-picture format having a smaller video-viewing area superimposed on a larger video-viewing area, and wherein the particular viewing sequence is displayed in the smaller video-viewing area.

12. The method of claim 7, further comprising the step of receiving audio content, wherein the customized output video includes the received audio content.

13. The method of claim 12, wherein the customized output video includes the received audio content in place of any audio content associated with any of the received plurality of video sequences.

14. A processor-accessible memory system storing instructions configured to cause a data processing system to implement a method for generating a video, wherein the instructions comprise:
instructions for receiving one or more input video sequences;
instructions for receiving a set of person-of-interest (“POI”) information identifying at least one person-of-interest;
instructions for identifying a particular video sequence that prominently or relatively prominently displays at least the person-of-interest, wherein the particular video sequence is identified from (a) the input video sequence(s), or (b) a portion of the input video sequence, if only one was received, or a portion of one of the input video sequences, if more than one was received;
instructions for generating a customized output video from at least a portion or portions of the input video sequence(s), the customized output video being generated based at least upon the set of POI information to include at least the particular video sequence; and
instructions for storing the customized output video in a processor-accessible memory system.

15. The processor-accessible memory system of claim 14,
wherein the input video sequence(s) include(s) images of an event spanning a period of time,
wherein the instructions further comprise instructions for receiving a set of times-of-interest (“TOI”) information,
wherein the TOI information identifies particular times-of-interest within the event's period of time, and
wherein the instructions for generating the customized output video include instructions for generating the customized output video to include video from the particular times-of-interest within the event's period of time based at least upon the TOI information.

16. The processor-accessible memory system of claim 14,
wherein the instructions for receiving one or more input video sequences are instructions for receiving a plurality of input video sequences, and
wherein the instructions for generating the customized output video include instructions for generating the customized output video from at least a portion or portions of at least two of the plurality of input video sequences.

17. The processor-accessible memory system of claim 14, wherein the instructions for generating the customized output video include instructions for generating the customized output video to include a picture-in-picture format having a smaller video-viewing area superimposed on a larger video-viewing area, and wherein the particular viewing sequence is displayed in the smaller video-viewing area.

18. A system comprising:
a data processing system;
an input system communicatively connected to the data processing system; and
a memory system communicatively connected to the data processing system and storing instructions configured to cause the data processing system to implement a method for generating a video, wherein the instructions comprise:
instructions for receiving one or more input video sequences via the input system;
instructions for receiving a set of person-of-interest (“POI”) information identifying at least one person-of-interest;
instructions for identifying a particular video sequence that prominently or relatively prominently displays at least the person-of-interest, wherein the particular video sequence is identified from (a) the input video sequence(s), or (b) a portion of the input video sequence, if only one was received, or a portion of one of the input video sequences, if more than one was received;
instructions for generating a customized output video from at least a portion or portions of the input video sequence(s), the customized output video being generated based at least upon the set of POI information to include at least the particular video sequence; and
instructions for storing the customized output video in a processor-accessible memory system.

19. The system of claim 18,
wherein the input video sequence(s) include(s) images of an event spanning a period of time,
wherein the instructions further comprise instructions for receiving a set of times-of-interest (“TOI”) information,
wherein the TOI information identifies particular times-of-interest within the event's period of time, and
wherein the instructions for generating the customized output video include instructions for generating the customized output video to include video from the particular times-of-interest within the event's period of time based at least upon the TOI information.

20. The system of claim 18, wherein the instructions for generating the customized output video include instructions for generating the customized output video to include a picture-in-picture format having a smaller video-viewing area superimposed on a larger video-viewing area, and wherein the particular viewing sequence is displayed in the smaller video-viewing area.
